(19) United States
(12) Patent Application Publication
(10) Pub. No.: US 2026/0075478 A1
(43) Pub. Date: Mar. 12, 2026

(54) HANDOVER METHOD AND APPARATUS

(71) Applicant: Honor Device Co., Ltd., Shenzhen (CN)

(72) Inventor: Baokun Shan, Shenzhen (CN)

(21) Appl. No.: 19/105,227

(22) PCT Filed: Aug. 29, 2023
(86) PCT No.: PCT/CN2023/115443

§ 371 Date: Feb. 20, 2025

(30) Foreign Application Priority Data
Sep. 9, 2022 (CN) 202211101844.6

(51) Int. Cl. H04W 36/00; H04W 36/08

(52) U.S. Cl. CPC H04W 36/0077; H04W 36/08

(57) ABSTRACT

This application provides a handover method and apparatus. User equipment UE obtains configuration information from a base station, where the configuration information indicates to transmit a handover complete message in a procedure of accessing a target cell; and transmits, based on the configuration information, the handover complete message in the procedure of accessing the target cell.

### CROSS-REFERENCED TO RELATED APPLICATIONS

This application is a national stage of International Application No. PCT/CN2023/115443, filed on Aug. 29, 2023, which claims priority to Chinese Patent Application No. 202211101844.6, filed on Sep. 9, 2022. The disclosures of both of the aforementioned applications are hereby incorporated by reference in their entireties.

### TECHNICAL FIELD

This application relates to the field of mobile communications technologies, and in particular, to a handover method and apparatus.

### BACKGROUND

In a cellular communication network system, a plurality of cells (cells) of a plurality of base stations cover a geographical range and provide a wireless communication service. User equipment (User Equipment, UE) usually performs a communication service in only one cell at a same moment. Handover (Handover) may occur when UE that is performing a service moves or a wireless environment changes greatly. The handover may be understood as a process of handing over the UE from one cell to another cell under control of a network.

How to optimize a handover procedure is one of problems that need to be researched.

### SUMMARY

This application provides a handover method and apparatus, to resolve a problem of how to optimize a handover procedure.

To achieve the foregoing objective, this application provides the following technical solutions.

A first aspect of this application provides a handover method, applied to user equipment UE handing over to a target cell. The handover method includes: obtaining configuration information (improved small data transmission configuration information) from a base station, where the configuration information indicates to transmit a handover complete message in a procedure of accessing the target cell; and transmitting, based on the configuration information, the handover complete message in the procedure of accessing the target cell. The handover complete message can be transmitted in the procedure of accessing the target cell, so that signaling overheads of handover can be reduced, and a handover delay can be reduced to reduce a service interruption possibility, thereby optimizing the handover procedure.

In some implementations, the configuration information includes: random access preamble information and information about a resource for transmitting the random access preamble information. The random access preamble information is specifically used for indicating to transmit a handover complete message in a procedure of randomly accessing the target cell, thereby laying a foundation for transmitting the handover complete message in the procedure of randomly accessing the target cell.

In some implementations, the transmitting the handover complete message in the procedure of accessing the target cell includes: sending an Msg3 to the target cell in a procedure of randomly accessing the target cell, where the Msg3 carries the handover complete message, thereby implementing transmission of the handover complete message in a 4-step random access procedure.

In some implementations, the transmitting the handover complete message in the procedure of accessing the target cell further includes: sending an Msg1 carrying preamble information to the target cell in a first available random access channel slot after reception of a handover command, or no later than an N^{th} available random access channel slot after reception of a handover command, where N is an integer, to initiate a random access procedure as soon as possible, thereby further reducing a handover delay.

In some implementations, the transmitting the handover complete message in the procedure of accessing the target cell includes: sending an MsgA to the target cell in a procedure of randomly accessing the target cell, where the MsgA carries the handover complete message, thereby implementing transmission of the handover complete message in a 2-step random access procedure.

In some implementations, the sending an MsgA to the target cell includes: sending the MsgA to the target cell in a first available random access channel slot after reception of a handover command, or no later than an N^{th} available random access channel slot after reception of a handover command, where N is an integer, to initiate a random access procedure as soon as possible, thereby further reducing a handover delay.

In some implementations, the configuration information includes: information about a preconfigured uplink transmission resource, thereby laying a foundation for transmitting the handover complete message in the procedure of accessing the target cell, in a case of handing over cells of a same base station.

In some implementations, the information about the uplink transmission resource includes: a radio network temporary identifier specifically used for transmission of the handover complete message in the procedure of accessing the target cell, time-frequency information used for an uplink resource, and information about an uplink transport block.

In some implementations, the transmitting, based on the configuration information, the handover complete message in the procedure of accessing the target cell includes: transmitting, by using the uplink transmission resource indicated by the information about the uplink transmission resource, a message used for accessing the target cell and the handover complete message to the target cell, to complete the handover complete message based on the preconfigured resource in the procedure of accessing the target cell.

In some implementations, the transmitting, by using the uplink transmission resource indicated by the information about the uplink transmission resource, a message used for accessing and the handover complete message to the target cell includes: transmitting the message used for accessing and the handover complete message to the target cell on a first available preconfigured uplink transmission resource or no later than an N^{th} available preconfigured uplink transmission resource, where N is an integer, to initiate an access procedure as soon as possible, thereby further reducing a handover delay.

In some implementations, the obtaining configuration information from a base station includes: receiving a message that carries the configuration information and that is sent by a base station to which a source cell belongs, where the message includes a radio resource control reconfiguration RRCReconfiguration message or media access control control signaling MAC CE, the RRCReconfiguration message can implement compatibility and commonality with a standard, and the MAC CE helps obtain a smaller delay.

Types of the RRCReconfiguration message and the handover complete message include: a radio resource control RRC message or a media access control control signaling MAC CE message. The RRC message can implement compatibility and commonality with a standard, and the MAC CE helps obtain a smaller delay.

In some implementations, before the obtaining configuration information from a base station, the method further includes: transmitting, in a state of setting up an RRC connection to the source cell, capability information (improved handover capability information) of the UE to the base station to which the source cell belongs, where the capability information indicates support of transmitting the handover complete message in the procedure of accessing the target cell, to lay a foundation for transmitting the handover complete message in the procedure of accessing the target cell.

In some implementations, before the transmitting, based on the configuration information, the handover complete message in the procedure of accessing the target cell, the method further includes: selecting, based on a handover condition of each candidate target cell, the target cell from the candidate target cells, where the handover condition includes a condition that is set based on an access procedure for transmitting the handover complete message, so that a condition about improving handover (the transmission of the handover complete message in the procedure of accessing the target cell) is added to a condition-based handover procedure, thereby helping further optimize a conditioned handover procedure.

A second aspect of this application provides a handover method, applied to a base station to which a target cell performing a handover procedure belongs. The method includes: sending configuration information in response to handover of user equipment UE from a source cell to the target cell being triggered, where the configuration information indicates to transmit a handover complete message in a procedure of accessing the target cell. The configuration information lays a foundation for completing the transmission of the handover complete message in the procedure of accessing the target cell, helps reduce signaling overheads of handover, and reduces a handover delay to reduce a service interruption possibility, thereby helping optimize the handover procedure.

In some implementations, the configuration information includes: random access preamble information and information about a resource for transmitting the random access preamble information. The random access preamble information is specifically used for indicating to transmit a handover complete message in a procedure of randomly accessing the target cell, thereby laying a foundation for transmitting the handover complete message in the procedure of randomly accessing the target cell.

In some implementations, the configuration information includes: information about a preconfigured uplink transmission resource, thereby laying a foundation for transmitting the handover complete message in the procedure of accessing the target cell, in a case of handing over cells of a same base station.

In some implementations, the information about the uplink transmission resource includes: a radio network temporary identifier specifically used for transmission of the handover complete message in the procedure of accessing the target cell, time-frequency information used for an uplink resource, and information about an uplink transport block.

In some implementations, the handover from a source cell to the target cell being triggered includes: receiving a handover request message sent by a base station to which the source cell belongs; and the sending configuration information includes: sending a handover response message to the base station to which the source cell belongs, where the handover response message carries the configuration information, to implement improved handover between different base stations.

In some implementations, the source cell and the target cell belong to the same base station; and the handover from a source cell to the target cell being triggered includes: receiving a measurement result sent by the UE; and the sending configuration information includes: sending a message that carries the configuration information to the UE, where the message includes an RRCReconfiguration message or a MAC CE, to implement improved handover between cells of a same base station.

In some implementations, before the sending configuration information, the method further includes: exchanging information with the base station to which the source cell belongs, where the information includes capability information or configuration information, and the capability information or the configuration information indicates support of transmitting the handover complete message in the procedure of accessing the target cell, to lay a foundation for improved handover.

In some implementations, before the sending configuration information, the method further includes: determining, in an admission control procedure based on capability information of the UE, that the UE is allowed to be handed over, where the capability information indicates support of transmitting the handover complete message in the procedure of accessing the target cell, to lay a foundation for improved handover.

A third aspect of this application provides a handover method, applied to a base station to which a source cell performing a handover procedure belongs. The method includes: determining, in response to a measurement result reported by user equipment UE, a target cell for performing the handover procedure; and transmitting, in response to obtaining configuration information from the target cell, the configuration information to the UE, where the configuration information indicates to transmit a handover complete message in a procedure of accessing the target cell. The configuration information lays a foundation for completing the transmission of the handover complete message in the procedure of accessing the target cell, helps reduce signaling overheads of handover, and reduces a handover delay to reduce a service interruption possibility, thereby helping optimize the handover procedure.

In some implementations, the configuration information includes: random access preamble information and information about a resource for transmitting the random access preamble information. The random access preamble information is specifically used for indicating to transmit a handover complete message in a procedure of randomly accessing the target cell, thereby laying a foundation for transmitting the handover complete message in the procedure of randomly accessing the target cell.

In some implementations, the configuration information includes: information about a preconfigured uplink transmission resource, thereby laying a foundation for transmitting the handover complete message in the procedure of accessing the target cell, in a case of handing over cells of a same base station.

In some implementations, the information about the uplink transmission resource includes: a radio network temporary identifier specifically used for transmission of the handover complete message in the procedure of accessing the target cell, time-frequency information used for an uplink resource, and information about an uplink transport block.

In some implementations, the transmitting the configuration information to the UE includes: sending a message that carries the configuration information to the UE, where the message includes a radio resource control reconfiguration RRCReconfiguration message or media access control control signaling MAC CE, the RRCReconfiguration message can implement compatibility and commonality with a standard, and the MAC CE helps obtain a smaller delay.

In some implementations, the determining a target cell for performing the handover procedure includes: determining the target cell from neighboring cells of the source cell based on the measurement result and capability information, where the capability information includes capability information of the UE and capability information of the cell, and the capability information indicates support of transmitting the handover complete message in the procedure of accessing the target cell, to lay a foundation for implementing transmission of the handover complete message in the procedure of accessing the target cell.

A fourth aspect of this application provides user equipment, including: a memory configured to store a program, and one or more processors configured to run the program to implement the handover method according to the first aspect of this application.

A fifth aspect of this application provides a base station, including: a memory configured to store a program, and one or more processors configured to run the program to implement the handover method according to the second aspect or the third aspect of this application.

A sixth aspect of this application provides a computer-readable storage medium, storing a program, where the handover method according to the first aspect, the second aspect, or the third aspect of this application is implemented when a computer device runs the application program.

A seventh aspect of this application provides a computer program product, where the computer program product, when run on a computer, enables the computer to perform the handover method according to the first aspect, the second aspect, or the third aspect of this application.

### BRIEF DESCRIPTION OF THE DRAWINGS

FIG. 1 is an example diagram of handover of a mobile phone during a call;

FIG. 2 is a flowchart of a handover method according to an embodiment of this application;

FIG. 3 is an example flowchart of accessing a target cell by UE in a handover method according to an embodiment of this application;

FIG. 4 is another example flowchart of accessing a target cell by UE in a handover method according to an embodiment of this application;

FIG. 5 is another example flowchart of accessing a target cell by UE in a handover method according to an embodiment of this application; and

FIG. 6 is a flowchart of another handover method according to an embodiment of this application.

### DETAILED DESCRIPTION OF ILLUSTRATIVE EMBODIMENTS

The following clearly and completely describes technical solutions in embodiments of this application with reference to the accompanying drawings in the embodiments of this application. Terms used in the following embodiments are only intended to describe particular embodiments, and are not intended to limit this application. As used in this specification and the claims of this application, a singular expression form, “one”, “a”, “said”, “foregoing”, “the”, or “this”, is intended to also include an expression form such as “one or more”, unless clearly indicated to the contrary in the context. It should be further understood that in the embodiments of this application, “one or more” means one, two, or more. The term “and/or” describes an association relationship between associated objects and represents that three relationships may exist. For example, A and/or B may represent: Only A exists, both A and B exist, and only B exists. A and B may be singular or plural. The character “/” generally indicates an “or”relationship between the associated objects.

Reference of “one embodiment”, “some embodiments”, or the like described in the specification means that a specific feature, structure, or characteristic described with reference to the embodiment is included in one or more embodiments of this application. Therefore, statements “in an embodiment”, “in some embodiments”, “in other embodiments”, “in further embodiments”, and the like appearing in different parts of this specification do not necessarily refer to a same embodiment, but mean “one or more but not all embodiments”, unless otherwise specified in other ways. The terms “include”, “contain”, “have”, and variations thereof all mean “including but not limited to”, unless otherwise specified in other ways.

“A plurality of” involved in the embodiments of this application means being greater than or equal to two. It should be noted that, in descriptions of the embodiments of this application, terms such as “first” and “second” are merely used for a purpose of distinguishing the descriptions and should not be construed as indicating or implying relative importance, nor as indicating or implying a sequence.

The embodiments of this application are applied to a communication system, which may be a second generation (2G) communication system, a third generation (3G) communication system, a long term evolution (long term evolution, LTE) system, a fifth generation (5G) communication system, a hybrid architecture of LTE and 5G, a 5G new radio (5G New Radio, 5G NR) system, a new communication system that appears in future communication development, or the like.

In the embodiments provided in this application, a base station may be any device that is located on a network side and that has a radio transceiver function, including but not limited to: an evolved NodeB (NodeB or eNB or e-NodeB, evolutional Node B) in long term evolution (long term evolution, LTE), a gNodeB (gNodeB or gNB) or a transmission/reception point (transmission receiving point/transmission reception point, TRP) in new radio (new radio, NR), a 3GPP subsequent evolved base station, an access node in a Wi-Fi system, a wireless relay node, a wireless backhaul node, and the like. The base station may be: a macro base station, a micro base station, a pico base station, a small station, a relay station, a balloon station, or the like. The base station may include one or more intra-base-station or inter-base-station transmission/reception points (Transmission Reception Point, TRP). The base station may alternatively be a wireless controller in a cloud radio access network (cloud radio access network, CRAN) scenario, a centralized unit (centralized unit, CU), and/or a distributed unit (distributed unit, DU). The base station may communicate with a terminal, or may communicate with the terminal through a relay station. The terminal may communicate with a plurality of base stations of different technologies. For example, the terminal may communicate with a base station supporting an LTE network, or may communicate with a base station supporting a 5G network, or may perform dual connectivity with a base station supporting an LTE network and a base station supporting a 5G network.

In the embodiments provided in this application, the terminal may be in various forms, for example, a mobile phone (mobile phone), a tablet computer (Pad), a computer with a wireless transceiver function, a virtual reality (virtual reality, VR) terminal device, an augmented reality (augmented reality, AR) terminal device, a wireless terminal in industrial control (industrial control), an in-vehicle terminal device, a wireless terminal in self driving (self driving), a wireless terminal in remote medical (remote medical), a wireless terminal in a smart grid (smart grid), a wireless terminal in transportation safety (transportation safety), a wireless terminal in a smart city (smart city), a wireless terminal in a smart home (smart home), a wearable terminal device, or the like. The terminal sometimes may also be referred to as a terminal device, user equipment (user equipment, UE), an access terminal device, an in-vehicle terminal, an industrial control terminal, a UE unit, a UE station, a mobile station, a console, a remote station, a remote terminal device, a mobile device, a UE terminal device, a wireless communication device, a UE agent, a UE apparatus, or the like. The terminal may alternatively be a fixed terminal or a mobile terminal. In the following embodiments of this application, as an example, the terminal is UE.

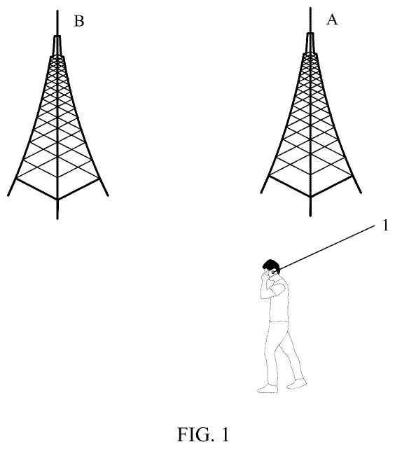

FIG. 1 is an example in which a mobile phone is handed over between cells. A user is making a call by using a mobile phone 1, and the mobile phone 1 performs a voice call service by using a cell of a base station A. As the user moves, a signal of the cell of the base station A becomes worse, and a handover procedure is triggered. It is assumed that a cell of a base station B is a target cell, and the mobile phone is handed over to the target cell of the base station B through the handover procedure.

A problem of a high delay may occur in a conventional handover procedure, and a relatively high delay may cause interruption of a service. Still using FIG. 1 as an example, a delay is relatively high for a mobile phone 1 to be handed over from a cell of a base station A to a cell of a base station B. In other words, the mobile phone 1 is not handed over to the cell of the base station B in a timely manner, but as a user moves, a signal of the cell of the base station A may be worse. Therefore, interruption of a voice service may be caused.

In addition, the conventional handover procedure further has a problem of large overheads.

In a research process, the inventor finds that a random access procedure in the handover procedure is one of reasons for a high delay and high overheads:

With reference to the existing handover procedure, after obtaining information about a target cell at a handover preparation stage, UE needs to access the target cell (through a generalized random access procedure, which is briefly referred to as an “access procedure” below) at a handover stage, that is, initiates the access procedure at the target cell. After the access procedure is completed and the UE accesses the target cell, the UE sends a handover complete message to a target base station, to complete a handover (that is, air interface handover) procedure between the UE and the base station. However, the access procedure includes a plurality of interaction processes of uplink and downlink signaling, resulting in a delay and signaling overheads. Therefore, the access procedure is one of reasons for a relatively high delay and relatively large overheads of the handover procedure.

To resolve the foregoing problem, the inventor finds through research that the handover complete message has a relatively small data volume, so that the handover complete message can be transmitted to the target cell in the random access procedure. Alternatively, in a case that uplink synchronization is not required, the handover complete message is transmitted, by using a preconfigured uplink resource, to the target cell in a procedure of accessing the target cell by the UE, to reduce a delay in the handover procedure and reduce overheads in the handover procedure.

For ease of description, due to the relatively small data volume of the handover complete message, random access for transmitting the handover complete message is referred to as “random access based on improved small data transmission”, and the procedure of transmitting the handover complete message by using the preconfigured uplink resource is referred to as “improved small data transmission based on a preconfigured resource (Configured Grant, CG)”. For ease of description, the “random access based on improved small data transmission” and the “improved small data transmission based on a CG” are collectively referred to as “improved small data transmission”. Handover including the “improved small data transmission”is referred to as “improved handover”.

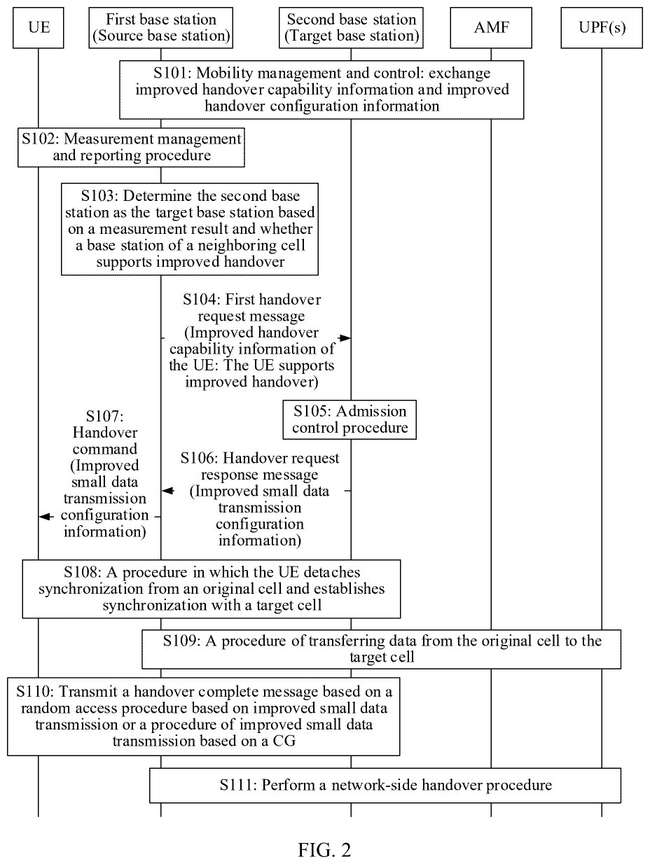

FIG. 2 is a flowchart of a handover method according to an embodiment of this application. In FIG. 2, a first base station and a second base station are wireless network devices. An access and mobility management function (Access and Mobility Management Function, AMF) and a user plane function (User Plane Function, UPF) are core network devices.

In FIG. 2, it is assumed that the first base station is a source base station, and before UE is handed over, a cell of the source base station is used to perform a service. It is assumed that the second base station is a base station to which a target cell selected through the following procedure belongs, and is referred to as a target base station. In the procedure shown in FIG. 2, the source base station and the target base station may be a same base station, or may be different base stations.

FIG. 2 includes the following steps:
S101: A network side performs a mobility management procedure.

In this embodiment, the mobility management procedure includes: exchanging information between base stations.

In some implementations, the information includes improved handover capability information. The improved handover capability information indicates whether improved handover is supported. For example, if the improved handover capability information is “1”, it indicates that improved handover is supported, or if the improved handover capability information is “0”, it indicates that improved handover is not supported.

It may be understood that the improved handover capability information is an explicit expression of whether the base station supports a capability of improved handover.

In some other implementations, the information includes improved handover configuration information. The improved handover configuration information represents information about a resource for improved small data transmission, and indicates that the base station has a capability of improved handover. That is, whether the base station supports improved handover can be implicitly expressed by using the improved handover configuration information.

The foregoing two manners both indicate that the base station supports improved handover. In FIG. 2, the first manner is used as an example.

The information may further include adjacency relationship information between a base station and a cell, used for subsequent mobility configuration for the UE.

It may be understood that, the base stations may directly exchange information, or may exchange information through the AMF. This is not limited herein. In addition, other steps in the mobility management procedure are not described in detail herein.
S102: UE and a source base station perform a measurement management and reporting procedure.

In some implementations, the source base station sends a radio resource control reconfiguration (Radio Resource Control Reconfiguration, RRCReconfiguration) message to the UE. The RRCReconfiguration message carries measurement configuration information. The measurement configuration information mainly includes a measurement trigger condition (for example, various signal thresholds for starting measurement), a measurement range (for example, a cell list and a frequency list), a time interval for measurement, and the like.

During a service, the UE continuously evaluates whether the measurement trigger condition is satisfied, and if the measurement trigger condition is satisfied (which is usually a case in which a serving cell signal becomes worse), the UE performs measurement and sends a measurement result to the source base station.
S103: The source base station determines a target cell from neighboring cells based on a measurement result and whether the neighboring cells support improved handover.

It may be understood that, the source base station determines, by using the information exchanged in S101, whether a base station of the neighboring cell supports improved handover.

An alternative step of S103 is: The source base station determines the second base station as the target base station based on a measurement result and whether the UE and the base station of the neighboring cell support improved handover. In this case, whether the UE supports improved handover is determined based on indication information of whether the UE supports improved handover. The indication information of whether the UE supports improved handover may be explicit capability information, for example, access stratum radio capability (AS radio capability, Access Stratum radio capability) information or non-access stratum capability (NAS capability, Non-Access Stratum capability) information that indicates whether the UE supports improved handover, or may be other information that may indicate whether the UE supports improved handover, for example, whether the UE supports improved small data transmission, or a protocol version number supported by the UE. This is not limited herein. The base station may obtain the indication information from the UE in a connected mode, or may obtain the indication information from a core network in an RRC link setup process of the UE or in an RRC link state.

In some implementations, if (at least one) cell of the second base station supports improved handover, signal strength of the cell in the measurement result is greater than a preset threshold, and the UE supports improved handover, the second base station is determined as the target base station.
S104: The source base station sends a first handover request message to a target base station.

The first handover request message carries improved handover capability information of the UE. The first handover request message further carries information (such as an ID) of UE serving as a terminal to be handed over and other related information.

In this embodiment, as an example, the improved handover capability information of the UE indicates that the UE supports improved handover.
S105: The target base station performs an admission control procedure in response to the first handover request message.

In some implementations, the admission control procedure includes: determining, based on that the improved handover capability information of the UE indicates that the UE supports improved handover and that load of the target base station allows the UE to be handed over, that the UE is allowed to be handed over.
S106: The target base station transmits a handover request response message to the source base station in a case in which the UE is allowed to be handed over.

The handover request response message carries improved small data transmission configuration information, and the improved small data transmission configuration information may be understood as: information indicating resources and parameters used for improved small data transmission.

In some implementations, the improved small data transmission configuration information includes information about resources and parameters for random access based on improved small data transmission.

The random access includes 4-step (step) random access and 2-step random access. Therefore, an example of the improved small data transmission configuration information is: 4-step random access preamble information (for example, a preamble or an index of a preamble), and information about a time-frequency resource for transmitting the 4-step random access preamble information. Another example of the improved small data transmission configuration information is: 2-step random access preamble information (for example, a preamble or an index of a preamble), information about a time-frequency resource for transmitting the 2-step random access preamble information, and information about a resource for sending a physical uplink shared channel (Physical Uplink Shared Channel, PUSCH) used by an MsgA.

In some implementations, to distinguish between the random access that carries the handover complete message in this procedure and conventional random access, the foregoing preamble information indicates the random access for transmitting the handover complete message. That is, at least one of content (such as a value) and a format (such as a length) of the preamble information is different from conventional preamble information that indicates random access.

In terms of dimensions of two types of random access: contention-based random access and non-contention-based random access, the foregoing preamble information may represent a type of preamble. That is, in addition to representing the random access carrying the handover complete message, the preamble information can further represent a preamble used for random access. That is, in this step, random access to be performed is configured as the non-contention-based random access. Alternatively, the foregoing preamble information may not represent any type of preamble. To be specific, the preamble information represents only the random access carrying the handover complete message. That is, in this step, random access to be performed is configured as the contention-based random access.

As described above, the target base station and the source base station are a same base station, that is, handover is performed between cells of the same base station. In this case, uplink synchronization with the base station no longer needs to be performed. Therefore, random access may not be performed, but only the handover complete message is transmitted to the base station based on the improved small data transmission based on a CG.

Therefore, in some other implementations, the improved small data transmission configuration information includes information about an uplink transmission resource used for transmission of a handover complete message. Examples of the uplink transmission resource include: a radio network temporary identifier (Radio Network Temporary Identifier, RNTI) specifically used for improved handover (which may be the same as or different from a C-RNTI carried in the conventional handover procedure), time-frequency information of an uplink resource, a size of an uplink transport block, and the like. That is, in a case in which the target base station and the source base station are the same base station, the UE transmits the handover complete message to the target cell by using small data transmission based on a CG.

In addition to the improved small data transmission configuration information, the handover request response message may further carry configuration information required by the UE to access the target cell, such as a cell radio network temporary identifier (Cell RNTI, C-RNTI).
S107: The source base station sends a handover command to the UE.

The handover command includes the improved small data transmission configuration information.

In some implementations, the handover command is carried in an RRCReconfiguration message to be transmitted to the UE. In some other implementations, the handover command is carried in media access control control signaling (Media Access Control, Control Element, MAC CE) to be transmitted to the UE. The MAC CE is signaling that is more bottom-layer, and therefore, has a lower transmission delay.

The handover signaling is used to trigger the UE to perform a handover procedure. Therefore, the handover command further includes information (such as an ID) of the target cell and related configuration information of the target cell.
S108: Perform a procedure in which the UE detaches synchronization from the source cell and establishes synchronization with the target cell.
S109: Perform a procedure of transferring data from the source cell to the target cell.

Specific steps of S108 and S109 are not described herein again.
S110: The UE performs, in the target cell, a random access procedure based on improved small data transmission or a procedure of improved small data transmission based on a CG.

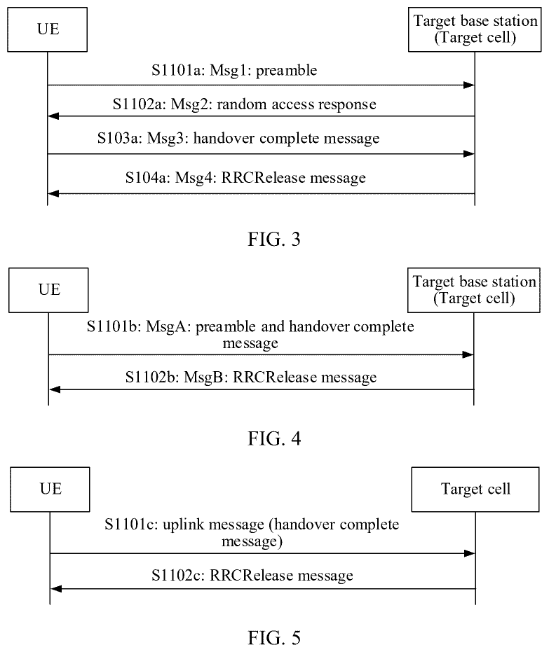

In some implementations, a specific implementation of S110 is shown in FIG. 3:
S1101a: The UE sends a message (Message, Msg) 1 including a preamble (or an index of the preamble) to the target cell, to trigger the random access procedure. The preamble and a resource used for sending the preamble are both indicated by the improved small data transmission configuration information received by the UE in S107.

As described above, the preamble is a preamble specifically used for random access in improved handover, to prompt the base station to provide a larger uplink scheduling grant (Uplink grant, UL grant), to add the handover complete message to an uplink message of the random access procedure.

To reduce a handover delay, the UE should perform S1101a as early as possible. For example, the UE performs S1101a in a first available random access channel slot (Random Access Channel occasion, RACH occasion) after reception of the handover command. For another example, after the UE receives the handover command, S1101a is performed no later than an N^{th} available RACH occlusion, where N is an integer, and may be configured by a network device, or may be agreed on in a protocol.
S1102a: The target cell sends an Msg2 including a random access response (Random access response, RAR) to the UE.

The RAR carries information about a UL grant used for sending an Msg3. As described above, the UL grant used for sending the Msg3 is greater than a UL grant in a conventional random access and handover procedure, so that the handover complete message is added to an uplink message of the random access procedure.
S1103a: The UE sends, based on a UL grant, an Msg3 including a handover complete message to the target cell.

In some implementations, a type of the handover complete message is an RRC message, such as a radio resource control reconfiguration complete (Radio Resource Control Reconfiguration Complete, RRCReconfigurationComplete) message. In some other implementations, a type of the handover complete message is a message type that is more bottom-layer, for example, a MAC CE indicating handover completion. Using a more bottom-layer message has advantages of a lower processing delay and lower overheads.

It may be understood that in addition to the foregoing information, the Msg1 to the Msg3 may further include other information in the random access procedure, and details are not described herein.

FIG. 3 shows a procedure of transmitting a handover complete message based on 4-step random access. The procedure further includes an Msg4. A message included in the Msg4 is not limited herein. For commonality with the existing 4-step random access and a procedure related thereto (for example, a small data transmission (SDT) procedure), an example of the Msg4 is an RRC release (RRCRelease) message. However, it may be understood that, because the UE is still performing a service when step S110 is performed, the RRCRelease message is not suitable for transmission in S110, but is transmitted on a suitable occasion after the service has been performed.

Alternatively, after S1103a, the target base station performs S1104a (as shown in FIG. 3), that is, transmits an RRCRelease message to the UE. However, the RRCRelease message does not indicate to release RRC, that is, the UE does not release an RRC connection after receiving the RRCRelease message.

Alternatively, an RRC message that represents RRC connection resumption (such as an RRCResume message) or that represents RRC connection setup (such as an RRCSetup message) or a MAC CE may be transmitted in S1104a.

In some other implementations, a specific implementation of S110 is shown in FIG. 4.
S1101b: The UE sends, to the target cell, an MsgA including a preamble and a handover complete message, where resources used for sending the MsgA are all indicated by the improved small data transmission configuration information received by the UE in S107. For a type of the handover complete message, refer to S1103a.

To reduce a handover delay, the UE should perform S1101b as early as possible. For an execution occasion, refer to an execution occasion of S1101a. For a type of the handover complete message, refer to S1103a.

FIG. 4 shows a procedure of transmitting a handover complete message based on 2-step random access. The procedure further includes an MsgB. A message included in the MsgB is not limited herein. For consistency with the existing 2-step random access and a procedure related thereto (for example, a small data transmission (SDT) procedure), an example of the MsgB is an RRC release (RRCRelease) message. However, it may be understood that, because the UE is still performing a service when step S110 is performed, the RRCRelease message is not suitable for transmission in S110, but is transmitted on a suitable occasion after the service has been performed.

Alternatively, after S1101b, the target base station performs S1102b (as shown in FIG. 4), that is, transmits an RRCRelease message to the UE. However, the RRCRelease message does not indicate to release RRC, that is, the UE does not release an RRC connection after receiving the RRCRelease message.

Alternatively, an RRC message that represents RRC connection resumption (such as an RRCResume message) or that represents RRC connection setup (such as an RRCSetup message) or a MAC CE may be transmitted in S1104a.

It may be understood that the random access procedure in FIG. 3 and FIG. 4 may be a contention-based random access procedure, or may be a non-contention-based random access procedure.

As described above, when handover is performed between cells of a same base station, uplink synchronization does not need to be performed with the base station to which the target cell belongs. Therefore, step S104 and step S105 may be skipped. Instead, after S103, S105 is performed, and after S105, S107 and subsequent steps are performed, to further reduce the delay and reduce the signaling overheads.

In addition, in still other implementations, a specific implementation of S110 is shown in FIG. 5: S1101c: The UE sends an uplink message including a handover complete message to the target cell. An objective of the uplink message is to access the target cell and transmit the handover complete message to the target cell. An example of the uplink message is a radio resource control resume request (Radio Resource Control Resume Request, RRCResumeRequest) message. However, it may be understood that, because the UE and the base station are in RRC connected mode in the handover procedure, a function of the RRCResumeRequest message is merely to carry the handover complete message instead of indicating to resume the RRC connection. That is, the target cell only obtains the handover complete message from the RRCResumeRequest message, but does not respond with an operation for the RRC connection.

The uplink message may alternatively be of another type. This is not limited herein.

To reduce a handover delay, the UE should perform S1101c as early as possible. For example, the UE performs S1101c on a first available CG resource. For another example, the UE performs S1101c no later than an N^{th} available CG resource, where N is an integer, and may be configured by a network device, or may be agreed on in a protocol.

It may be understood that, the UE transmits the uplink message by using the uplink transmission resource transmitted in S106.

In some implementations, after S1101c, a step of transmitting, by the target cell, a downlink message to the source cell is further performed. The downlink message may be an RRCRelease message. However, it may be understood that when step S110 is performed, the UE is still performing a service. Therefore, the RRCRelease message is not suitable for transmission in S110, but is transmitted on a suitable occasion after the service has been performed.

Alternatively, after S1101c, the target base station performs S1102c (as shown in FIG. 5), that is, transmits an RRCRelease message to the UE. However, the RRCRelease message does not indicate to release an RRC connection, that is, the UE does not release the RRC connection after receiving the RRCRelease message.

Alternatively, an RRC message that represents RRC connection resumption (such as an RRCResume message) or that represents RRC connection setup (such as an RRCSetup message) or a MAC CE may be transmitted in S1104a.

After the random access procedure is completed, the target cell sends a handover success message to the source cell, and the source cell sends SN STATUS TRANSFER to the target cell.

After S110 is performed, it may be considered that the handover between the UE and the base station (that is, an air interface) is completed.
S111: Perform a network-side handover procedure.

It may be understood that the network-side handover procedure is completed by exchanging data among the network side device, the source base station, the target base station, the AMF, and the UPF. Details are not described herein.

It can be learned from the procedure shown in FIG. 2 that, the UE transmits the handover complete message to the target cell through improved small data transmission. In one case, the improved small data transmission is performed in the random access procedure. In another case, the improved small data transmission is implemented based on a CG. Both a delay and overheads of handover can be reduced. The reduction of the delay can reduce a possibility of service interruption caused by an excessively long handover delay.

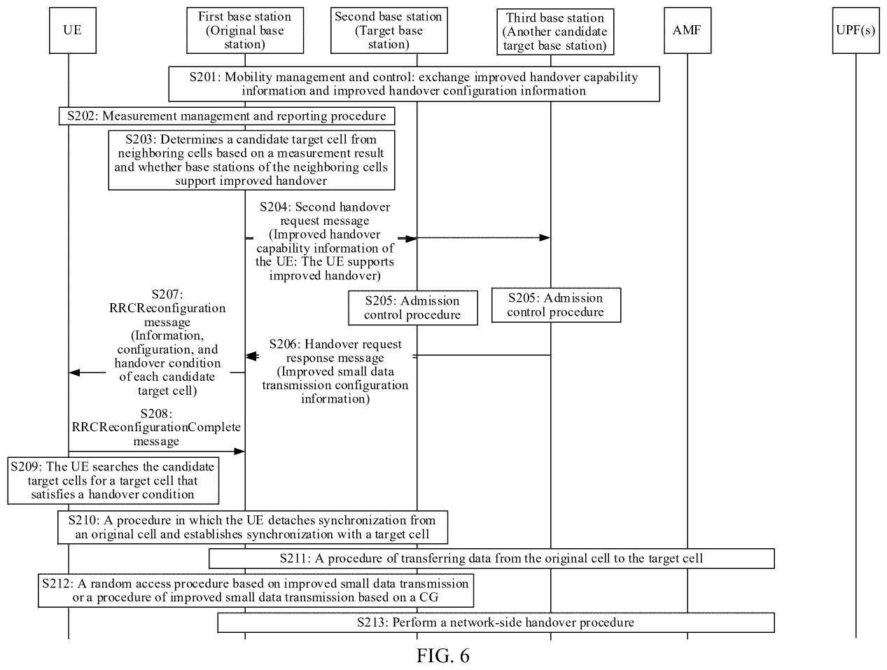

FIG. 6 shows another handover method according to an embodiment of this application. A difference from FIG. 2 lies in that a handover procedure shown in FIG. 4 is a conditional handover procedure, to resolve a problem that when UE moves excessively fast, quality of a network degrades excessively fast, resulting in service interruption caused by disconnection of the UE from the network.

FIG. 6 includes the following steps:
S201: A network side performs a mobility management procedure. For details, refer to S101, which is not described herein again.
S202: UE and a source base station perform a measurement management and reporting procedure. For details, refer to S102, which is not described herein again.
S203: The source base station determines candidate target cells from neighboring cells based on a determining condition.

In this step, the determining condition includes a measurement result, and may further include whether the neighboring cell supports improved handover, and the like. It may be understood that, the candidate target cell obtained through determining based on the determining condition may support improved handover or may not support improved handover.

It may be understood that, there is at least one candidate target cell. In FIG. 6, as an example, at least one cell of a second base station and at least one cell of a third base station are candidate target cells. A base station to which a candidate cell belongs is referred to as a candidate target base station.

For a specific determining manner, refer to S103.
S204: The source base station sends a second handover request message to a candidate target base station.

The second handover request message carries improved handover capability information of the UE. The second handover request message further carries information (such as an ID) of UE serving as a terminal to be handed over and other related information.

In this embodiment, as an example, the improved handover capability information of the UE indicates that the UE supports improved handover.

It may be understood that, the second handover request message and the first handover request message may both indicate improved handover. Alternatively, the first handover request indicates an improved handover procedure shown in FIG. 2, and the second handover request indicates the improved conditional handover procedure described in this embodiment (that is, shown in FIG. 6).
S205: The candidate target base station performs an admission control procedure in response to the second handover request.

For a specific implementation of an admission control procedure of any candidate target base station, refer to S105.
S206: The candidate target base station transmits a handover request response message to the source base station in a case in which the UE is allowed to be handed over.

The handover request response message carries improved small data transmission configuration information. For specific content of the improved small data transmission configuration information, refer to S106. The handover request response message may further carry configuration information required by the UE to access the target cell, such as a C-RNTI.

As described above, the candidate target cell obtained through determining based on the determining condition may support improved handover or may not support improved handover. Therefore, only handover request response messages sent by some candidate target base stations may carry transmission configuration information.
S207: The source base station sends an RRCReconfiguration message to the UE.

The RRCReconfiguration message carries information (such as an ID) of each candidate target cell, a handover-related configuration of each candidate target cell, and a handover condition (such as a signal strength measurement threshold) for handover to each candidate target cell.
S208: The UE sends an RRCReconfigurationComplete message to the source base station.

The RRCReconfigurationComplete message represents successful reception of the RRCReconfiguration message.
S209: The UE searches, based on the RRCReconfiguration message, the candidate target cells for a cell that satisfies a handover condition, as a target cell.

A target candidate cell that satisfies the handover condition is referred to as the target cell.

In some implementations, the handover condition includes a condition related to improved small data transmission (that is, improved handover). In addition, a priority of each condition in the handover condition can be set, to improve a degree of impact of some conditions on selection of the target cell.

In some other implementations, the UE preferentially selects a target cell from candidate target cells supporting improved handover.
S210: A procedure in which a UE detaches synchronization from the source cell and establishes synchronization with the target cell.
S211: Perform a procedure of transferring data from the source cell to the target cell.
S212: The UE performs a random access procedure in the target cell.

For a specific implementation, refer to S110, that is, as shown in FIG. 3, FIG. 4, or FIG. 5.

After the random access procedure is completed, the target cell sends a handover success message to the source cell, and the source cell sends SN STATUS TRANSFER and a handover cancellation message to the target cell.
S213: Perform a network-side handover procedure.

In the handover procedure shown in FIG. 6, improved small data transmission is integrated during the conditional handover, to reduce a delay and overheads of handover.

It can be learned with reference to FIG. 3, FIG. 4, and FIG. 5 that the improved small data transmission provided in the embodiments of this application may have the following features:

A step of determining a size of a data packet is not performed. This is because for the scenario of handover, a data volume of the handover complete message is usually relatively small. Therefore, whether a condition for a small data packet is satisfied does not need to be determined.

A step of determining signal strength of a cell is not performed. This is because for the scenario of handover, the target cell is a cell that is determined based on signal measurement and that has a relatively good signal. In other words, there is a high probability that the target cell has a relatively good signal. Therefore, the signal of the target cell does not need to be determined.

Based on the foregoing features, the improved small data transmission provided in the embodiments of this application can reduce measurement threshold determining and data volume determining, thereby reducing procedure complexity and reducing overheads.

1. A handover method, applied to user equipment UE handing over to a target cell, wherein the method comprises:
obtaining configuration information from a base station, wherein the configuration information indicates to transmit a handover complete message in a procedure of accessing the target cell; and
transmitting, based on the configuration information, the handover complete message in the procedure of accessing the target cell;
wherein the configuration information comprises:
random access preamble information and information about a resource for transmitting the random access preamble information, wherein
the random access preamble information is specifically used for indicating to transmit a handover complete message in a procedure of randomly accessing the target cell ;
wherein the transmitting the handover complete message in the procedure of accessing the target cell further comprises:
sending an Msg1 carrying preamble information to the target cell in a first available random access channel slot after reception of a handover command, or no later than an N^{th} available random access channel slot after reception of a handover command, wherein N is an integer.

2. (canceled)

3. The method according to claim 1, wherein the transmitting the handover complete message in the procedure of accessing the target cell comprises:
sending an Msg3 to the target cell in a procedure of randomly accessing the target cell, wherein the Msg3 carries the handover complete message.

4. (canceled)

5. The method according to claim 1, wherein the transmitting the handover complete message in the procedure of accessing the target cell comprises:
sending an MsgA to the target cell in a procedure of randomly accessing the target cell, wherein the MsgA carries the handover complete message;
wherein the sending an MsgA to the target cell comprises:
sending the MsgA to the target cell in a first available random access channel slot after reception of a handover command, or no later than an N^{th} available random access channel slot after reception of a handover command, wherein N is an integer.

6. (canceled)

7. The method according to claim 1, wherein the configuration information comprises:
information about a preconfigured uplink transmission resource.

8. The method according to claim 7, wherein the information about the uplink transmission resource comprises:
a radio network temporary identifier specifically used for transmission of the handover complete message in the procedure of accessing the target cell, time-frequency information used for an uplink resource, and information about an uplink transport block.

9. The method according to claim 7, wherein the transmitting, based on the configuration information, the handover complete message in the procedure of accessing the target cell comprises:
transmitting, by using the uplink transmission resource indicated by the information about the uplink transmission resource, a message used for accessing the target cell and the handover complete message to the target cell;
wherein the transmitting, by using the uplink transmission resource indicated by the information about the uplink transmission resource, a message used for accessing and the handover complete message to the target cell comprises:
transmitting the message used for accessing and the handover complete message to the target cell on a first available preconfigured uplink transmission resource or no later than an N^{th} available preconfigured uplink transmission resource, wherein N is an integer.

10. -12. (canceled)

13. The method according to claim 1, wherein before the obtaining configuration information from a base station, the method further comprises:
transmitting, in a state of setting up an RRC connection to the source cell, capability information of the UE to the base station to which the source cell belongs, wherein the capability information indicates support of transmitting the handover complete message in the procedure of accessing the target cell.

14. The method according to claim 1, wherein before the transmitting, based on the configuration information, the handover complete message in the procedure of accessing the target cell, the method further comprises:
selecting, based on a handover condition of each candidate target cell, the target cell from the candidate target cells, wherein the handover condition comprises a condition that is set based on an access procedure for transmitting the handover complete message.

15. A handover method, applied to a base station to which a target cell performing a handover procedure belongs, wherein the method comprises:
sending configuration information in response to handover of user equipment UE from a source cell to the target cell being triggered, wherein the configuration information indicates to transmit a handover complete message in a procedure of accessing the target cell;
wherein the configuration information comprises:
random access preamble information and information about a resource for transmitting the random access preamble information, wherein
the random access preamble information is specifically used for indicating to transmit the handover complete message in the procedure of accessing the target cell.

16. (canceled)

17. The method according to claim 15, wherein the configuration information comprises:
information about a preconfigured uplink transmission resource.

18. The method according to claim 17, wherein the information about the uplink transmission resource comprises:
a radio network temporary identifier specifically used for transmission of the handover complete message in the procedure of accessing the target cell, time-frequency information used for uplink transmission, and information about an uplink transport block.

19. The method according to claim 15, wherein the handover from a source cell to the target cell being triggered comprises:
receiving a handover request message sent by a base station to which the source cell belongs; and
the sending configuration information comprises:
sending a handover response message to the base station to which the source cell belongs, wherein the handover response message carries the configuration information.

20. The method according to claim 15, wherein the source cell and the target cell belong to the same base station; and
the handover from a source cell to the target cell being triggered comprises:
receiving a measurement result sent by the UE; and
the sending configuration information comprises:
sending a message that carries the configuration information to the UE, wherein the message comprises a radio resource control reconfiguration RRCReconfiguration message or media access control control signaling MAC CE.

21. The method according to claim 15, wherein before the sending configuration information, the method further comprises:
exchanging information with the base station to which the source cell belongs, wherein the information comprises capability information or configuration information, and the capability information or the configuration information indicates support of transmitting the handover complete message in the procedure of accessing the target cell.

22. The method according to claim 15, wherein before the sending configuration information, the method further comprises:
determining, in an admission control procedure based on capability information of the UE, that the UE is allowed to be handed over, where the capability information indicates support of transmitting the handover complete message in the procedure of accessing the target cell.

23. A handover method, applied to a base station to which a source cell performing a handover procedure belongs, wherein the method comprises:
determining, in response to a measurement result reported by user equipment UE, a target cell for performing the handover procedure; and
transmitting, in response to obtaining configuration information from the target cell, the configuration information to the UE, wherein the configuration information indicates to transmit a handover complete message in a procedure of accessing the target cell;
wherein the configuration information comprises:
random access preamble information and information about a resource for transmitting the random access preamble information, wherein
the random access preamble information is specifically used for indicating to transmit the handover complete message in the procedure of accessing the target cell.

24. (canceled)

25. The method according to claim 23, wherein the configuration information comprises:
information about a preconfigured uplink transmission resource.

26. The method according to claim 25, wherein the information about the uplink transmission resource comprises:
a radio network temporary identifier specifically used for transmission of the handover complete message in the procedure of accessing the target cell, time-frequency information used for uplink transmission, and information about an uplink transport block.

27. The method according to claim 23, wherein the transmitting the configuration information to the UE comprises:
sending a message that carries the configuration information to the UE, wherein the message comprises a radio resource control reconfiguration RRCReconfiguration message or media access control control signaling MAC CE.

28. The method according to claim 23, wherein the determining a target cell for performing the handover procedure comprises:
determining the target cell from neighboring cells of the source cell based on the measurement result and capability information, wherein the capability information comprises capability information of the UE and capability information of the cell, and the capability information indicates support of transmitting the handover complete message in the procedure of accessing the target cell.

29.-31. (canceled)
